(19) United States
(12) Patent Application Publication
(10) Pub. No.: US 2026/0320281 A1
(43) Pub. Date: Oct. 15, 2026

(54) METHOD AND APPARATUS FOR ACCESSING DOCUMENT, DEVICE, MEDIUM, AND PROGRAM PRODUCT

(71) Applicant: Beijing Zitiao Network Technology Co., Ltd., Beijing (CN)

(72) Inventors: Jianfeng NI, Beijing (CN); Ziqing XU, Beijing (CN)

(21) Appl. No.: 19/108,425

(22) PCT Filed: Sep. 20, 2023
(86) PCT No.: PCT/CN2023/120204

§ 371 Date: Mar. 3, 2025

(30) Foreign Application Priority Data
Oct. 31, 2022 (CN) 202211353559.3

(51) Int. Cl. G06F 40/109; G06F 21/62; G06F 40/166; H04L 51/04

(52) U.S. Cl. CPC G06F 40/109; G06F 21/6209; G06F 40/166; H04L 51/04; G06F 2221/2141

(57) ABSTRACT

The present disclosure provides a method and apparatus for accessing a document, a device, a storage medium, and a program product. The method includes: displaying a reference identification in response to a focus being located on a first content block of a first document, wherein the first content block is a content block that has been referenced by at least one second document; displaying, in an association area of the first content block, reference information of the first content block in response to detecting a first trigger operation for the reference identification, wherein the reference information comprises information of the second document; and highlighting a first content area in the first document in response to detecting a second trigger operation for the information of the second document, wherein the first content area at least comprises the first content block.

The present application claims the benefit of Chinese Patent Application No. 202211353559.3, filed on Oct. 31, 2022, which is incorporated herein by reference in its entirety.

### TECHNICAL FIELD

The present disclosure relates to the field of computer technologies, and in particular, to a method and apparatus for accessing a document, a device, a medium, and a program product.

### BACKGROUND

A cloud document can meet the requirements of a user for flexible sharing and document collaboration by multiple persons. The cloud document often references content of another document. When content of a first document is referenced by different documents, an owner of the first document cannot learn related information about these documents, and cannot learn content of the first document that is referenced by these documents, which causes inconvenience to users of the first document.

### SUMMARY

The present disclosure provides a method and apparatus for accessing a document, a device, a storage medium, and a program product, to solve the technical problem of inability to view reference information of content in a first document that is referenced, to some extent.

In a first aspect, the present disclosure provides a method for accessing a document, the method including:
displaying a reference identification in response to a focus being located on a first content block of a first document, where the first content block is a content block that has been referenced by at least one second document;
displaying, in an association area of the first content block, reference information of the first content block in response to detecting a first trigger operation for the reference identification, where the reference information comprises information of the second document; and
highlighting a first content area in the first document in response to detecting a second trigger operation for the information of the second document, where the first content area at least comprises the first content block.

In a second aspect, the present disclosure provides an apparatus for accessing a document, including:
a display module, configured to a reference identification in response to a focus being located on a first content block of a first document, where the first content block is a content block that has been referenced by at least one second document; and
display, in an association area of the first content block, reference information of the first content block in response to detecting a first trigger operation for the reference identification, where the reference information comprises information of the second document; and
highlight a first content area in the first document in response to detecting a second trigger operation for the information of the second document, where the first content area at least comprises the first content block.

In a third aspect, the present disclosure provides an electronic device including one or more processors, a memory, and one or more programs, where the one or more programs are stored in the memory and are executed by the one or more processors, and the programs include instructions for performing the method according to the first aspect or the second aspect.

In a fourth aspect, the present disclosure provides a non-transitory computer-readable storage medium containing a computer program that, when executed by one or more processors, causes the processors to perform the method according to the first aspect or the second aspect.

In a fifth aspect, the present disclosure provides a computer program product including computer program instructions that, when running on a computer, cause the computer to perform the method according to the first aspect.

It can be seen from the foregoing description that, in the method and apparatus for accessing a document, the device, the medium, and the program product provided in the present disclosure, information about a second document that references a first content block is displayed in an association area of the first content block that is referenced in a first document, to display reference information of the first content block; and a first content block including a first content area is highlighted when information in a second document is triggered. This enables a person associated with the first document to quickly and efficiently view related reference information of each referenced content block, improving the convenience of document collaboration.

### BRIEF DESCRIPTION OF THE DRAWINGS

In order to more clearly describe the technical solutions in the present disclosure or the related art, the following briefly describes the accompanying drawings for describing the embodiments or the related art. Apparently, the accompanying drawings in the following description show merely some embodiments of the present disclosure, and a person of ordinary skill in the art may still derive other drawings from these accompanying drawings without creative efforts.

FIG. 1 is a schematic diagram of an access architecture of a document according to embodiments of the present disclosure.

FIG. 2 is a schematic diagram of a hardware structure of an exemplary electronic device according to embodiments of the present disclosure.

FIG. 3 is a schematic diagram of a first document according to embodiments of the present disclosure.

FIG. 4 is a schematic diagram of an association area of a content block according to embodiments of the present disclosure.

FIG. 5 is a schematic diagram of reference information according to embodiments of the present disclosure.

FIG. 6 is a schematic diagram of a second document according to embodiments of the present disclosure.

FIG. 7 is a schematic diagram of an interface of referrer information according to embodiments of the present disclosure.

FIG. 8 is a schematic diagram of a second content area according to embodiments of the present disclosure.

FIG. 9 is a schematic flowchart of a method for accessing a document according to embodiments of the present disclosure.

FIG. 10 is a schematic diagram of an apparatus for accessing a document according to embodiments of the present disclosure.

### DETAILED DESCRIPTION

To make the objectives, technical solutions, and advantages of the present disclosure clearer, the present disclosure is further described in detail below with reference to specific embodiments and the accompanying drawings.

It should be noted that, unless otherwise defined, the technical terms or scientific terms used in the embodiments of the present disclosure shall have the usual meanings understood by a person skilled in the art to which the present disclosure belongs. The “first”, “second”, and similar words used in the embodiments of the present disclosure do not indicate any order, quantity, or importance, but are merely used to distinguish different components. The words such as “include” or “include” mean that the elements or objects appearing before the word cover the elements or objects listed after the word and their equivalents, but do not exclude other elements or objects. The words such as “connected” or “connected” are not limited to physical or mechanical connections, but may include electrical connections, whether direct or indirect. “Upper”, “lower”, “left”, “right”, etc. are only used to indicate relative position relationships. When the absolute position of the described object changes, the relative position relationship may also change accordingly.

At present, there is often a scenario of mutual reference between documents in a document collaboration mode by multiple persons, and content of different parts in a first document may be referenced by one or more different documents. However, a person associated with the first document cannot learn which part of the content of the first document is referenced by which documents, and which content in the first document is referenced by the same document. Therefore, how to display reference information of content in the first document to improve the convenience of document collaboration has become a technical problem to be solved urgently.

In view of this, the embodiments of the present disclosure provide a method and apparatus for accessing a document, a device, a storage medium, and a program product. Information about a second document that references a first content block is displayed in an association area of the first content block that is referenced in a first document, to display reference information of the first content block; and a first content block including a first content area is highlighted when information in a second document is triggered. This enables a person associated with the first document to quickly and efficiently view related reference information of each referenced content block, improving the convenience of document collaboration.

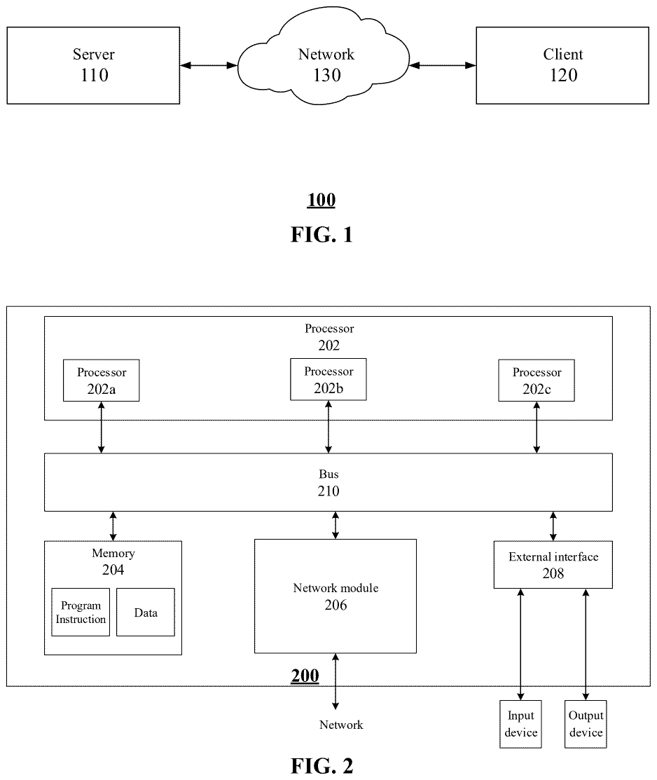

FIG. 1 is a schematic diagram of an access architecture of a document according to embodiments of the present disclosure. With reference to FIG. 1, the access architecture 100 of the document may include a server 110, a terminal 120, and a network 130 that provides a communication link. The server 110 and the terminal 120 may be connected via a wired or wireless network 130. The server 110 may be an independent physical server, or may be a server cluster or distributed system composed of a plurality of physical servers, or may be a cloud server that provides basic cloud computing services such as cloud service, cloud database, cloud computing, cloud function, cloud storage, network service, cloud communication, middleware service, and the like.

The terminal 120 may be implemented by hardware or software. For example, when the terminal 120 is implemented by hardware, it may be various electronic devices with a display screen and supporting page display, including but not limited to a smart phone, a tablet computer, an e-book reader, a laptop portable computer, and a desktop computer. When the terminal 120 is implemented by software, it may be installed in the foregoing listed electronic devices. It may be implemented as multiple software or software modules (for example, software or software modules used to provide distributed services), or may be implemented as a single software or software module, which is not specifically limited here.

It should be noted that the method for accessing a document provided in the embodiments of the present application may be performed by the terminal 120, or may be performed by the server 110. It should be understood that the number of terminals, networks, and servers in FIG. 1 is only schematic, and is not intended to limit them. Depending on implementation requirements, there may be any number of terminals, networks, and servers.

FIG. 2 is a schematic diagram of a hardware structure of an exemplary electronic device 200 according to embodiments of the present disclosure. As shown in FIG. 2, the electronic device 200 may include: a processor 202, a memory 204, a network module 206, a peripheral interface 208, and a bus 210. The processor 202, the memory 204, the network module 206, and the peripheral interface 208 are communicatively connected to each other in the electronic device 200 via the bus 210.

The processor 202 may be a central processing unit (CPU), a graphics processor, a neural network processor (NPU), a microcontroller (MCU), a programmable logic device, a digital signal processor (DSP), an application specific integrated circuit (ASIC), or one or more integrated circuits. The processor 202 may be used to perform functions related to the techniques described in the present disclosure. In some embodiments, the processor 202 may further include a plurality of processors integrated into a single logical component. For example, as shown in FIG. 2, the processor 202 may include a plurality of processors 202a, 202b, and 202c.

The memory 204 may be configured to store data (for example, an instruction, computer code, etc.). As shown in FIG. 2, the data stored in the memory 204 may include a program instruction (for example, a program instruction for implementing the method for accessing a document according to the embodiments of the present disclosure) and data to be processed (for example, the memory may store a configuration file of another module, etc.). The processor 202 may also access the program instruction and data stored in the memory 204, and execute the program instruction to operate on the data to be processed. The memory 204 may include a volatile storage apparatus or a non-volatile storage apparatus. In some embodiments, the memory 204 may include a random access memory (RAM), a read-only memory (ROM), an optical disc, a magnetic disc, a hard disc, a solid-state drive (SSD), a flash memory, a memory stick, etc.

The network module 206 may be configured to provide communication with another external device for the electronic device 200 via a network. The network may be any wired or wireless network capable of transmitting and receiving data. For example, the network may be a wired network, a local wireless network (for example, Bluetooth, WiFi, near field communication (NFC), etc.), a cellular network, the Internet, or a combination thereof. It can be understood that the type of the network is not limited to the foregoing specific examples. In some embodiments, the network module 306 may include any combination of any number of network interface controllers (NICs), radio frequency modules, transceivers, modems, routers, gateways, adapters, cellular network chips, etc.

The peripheral interface 208 may be configured to connect the electronic device 200 to one or more peripheral devices to implement information input and output. For example, the peripheral devices may include input devices such as a keyboard, a mouse, a touchpad, a touchscreen, a microphone, and various sensors, and output devices such as a display, a speaker, a vibrator, and an indicator light.

The bus 210 may be configured to transmit information between various components (for example, the processor 202, the memory 204, the network module 206, and the peripheral interface 208) of the electronic device 200, such as an internal bus (for example, a processor-memory bus), an external bus (a USB port, a PCI-E bus), etc.

It should be noted that although the architecture of the electronic device 200 only shows the processor 202, the memory 204, the network module 206, the peripheral interface 208, and the bus 210, in a specific implementation process, the architecture of the electronic device 200 may further include other components necessary for normal operation. In addition, a person skilled in the art may understand that the architecture of the electronic device 200 may also include only components necessary for implementing the solution of the embodiments of the present disclosure, rather than all components shown in the figure.

A user userA may upload a first document documentA (the first document documentA is a source document) to a cloud. The first document may refer to a referenced document, and the user userA is a document owner userA of the first document documentA. The document owner userA may set an access permission for the first document documentA for a visitor. For example, the access permission may include a read permission or an edit permission. The read permission indicates that a user can access and read content of the first document documentA, but cannot perform any operation on the first document documentA, such as editing and commenting. The edit permission indicates that the user can access and read the content of the first document documentA, and can also perform an edit operation on the content of the first document documentA, such as modifying, adding, and removing. It should be understood that the document owner userA may directly set an access permission for a single user. For example, an access permission of a certain user is directly set as a read permission or an edit permission. Alternatively, the document owner userA may set an access permission for a category of users in batch. For example, an access permission of a user set (such as a group or department) is set as a read permission or an edit permission, and an access permission of all collaborators in the set is a read permission or an edit permission.

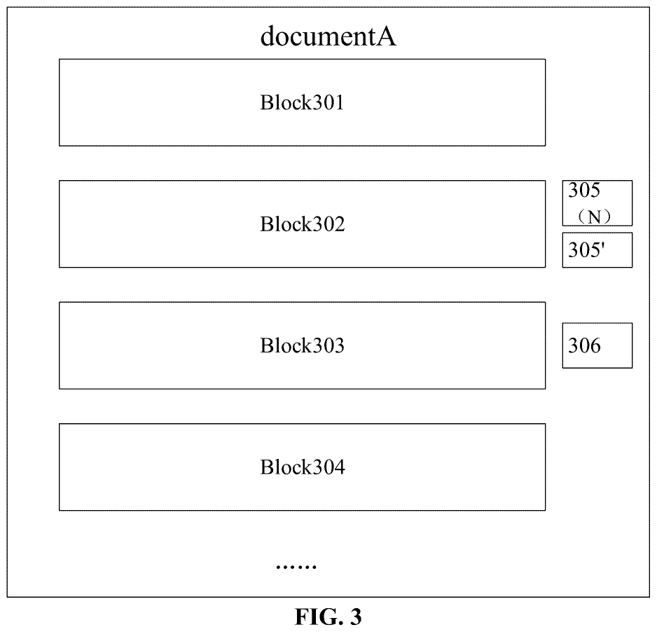

Referring to FIG. 3, FIG. 3 shows a schematic diagram of a first document according to embodiments of the present disclosure. In FIG. 3, the first document documentA includes content blocks Block301, Block302, Block303, Block304, etc. The content blocks Block302 and Block303 are referenced by a second document, which may refer to a document that references the content block in the first document. In some embodiments, a corresponding reference identification 305 is displayed in an association area of the content block Block302, and a corresponding reference identification 306 is displayed in an association area of the content block Block303. The reference identification 305 or the reference identification 306 may indicate that the corresponding content block Block302 or Block303 is referenced.

In some embodiments, display a reference identification in response to a focus being located on a first content block of a first document, where the first content block is a content block that has been referenced by at least one second document. For example, as shown in FIG. 3, the user may perform an operation O1 (for example, mouse hovering, clicking, etc.) on the content block Block302 or the content block Block303. In this case, the first content block is the content block Block302 or the content block Block303. Through the operation O1, the focus may be focused on the first content block of the first document. In response to the focus being located on the first content block Block302 or Block303, the reference identification is displayed. Further, the reference identification 305 may be displayed in the association area of the content block Block302, or the reference identification 306 may be displayed in the association area of the content block Block303.

In some embodiments, the reference identification may include a number identification for indicating a number of the second documents. The number identification may be displayed in the reference identification, for example, a number identification, to identify a number of second documents that reference the content block. For example, in FIG. 3, the reference identification 305 may include a number identification N, indicating that a number of second documents that apply the first content block Block302 is N, and N is a positive integer.

In some embodiments, when the reference identification is displayed, a comment identification about the first content block is also displayed. The comment identification may be used to display comment content of the corresponding content block or comment on the content block. For example, in FIG. 3, the user may view the comment content of the content block Block302 or comment on the content block Block302 by triggering the comment identification 305′ of the content block Block302.

In some embodiments, the reference identification may be displayed for a user who has an access permission for the first document; and/or the reference identification is refused from being displayed for a user who does not have an access permission for the first document.

The document owner userA of the first document documentA may set an access permission AuthorityA for the first document documentA. For example, the access permission AuthorityA may be set to an edit permission or a read permission, that is, a user with an edit permission or a read permission may access the first document documentA. If the user has neither a read permission nor an edit permission, the user cannot access the first document documentA. Accordingly, the reference identification of the content block may be displayed for a user with the access permission AuthorityA of the first document documentA. For example, a user with the access permission Authority A of the first document documentA may see the reference identification 305 or 306 in FIG. 3. Further, for a user who does not have the access permission AuthorityA of the first document documentA, the reference identification of the content block may be refused from being displayed. For example, a user who does not have the access permission Authority A of the first document documentA cannot see the reference identification 305 or 306 in FIG. 3.

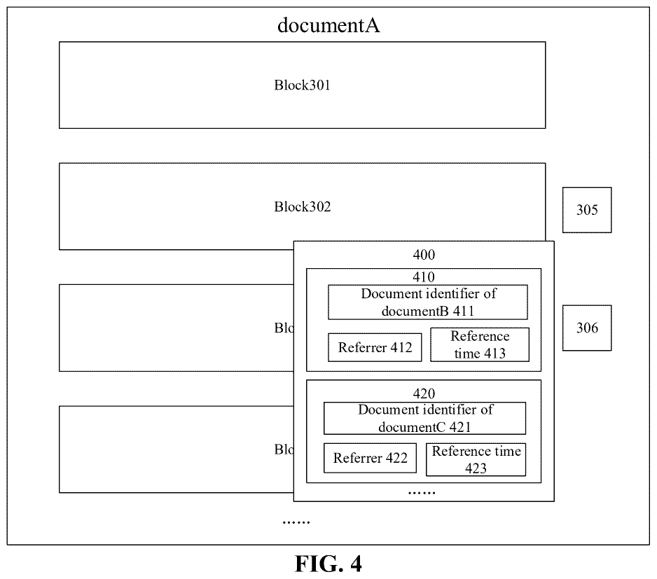

In some embodiments, the user may further perform a first trigger operation O2 (for example, mouse hovering, clicking, etc.) on the reference identification 305 or the reference identification 306. In response to the first trigger operation O2, reference information of the first content block may be displayed in an association area of the first content block, where the reference information includes information of the second document. Specifically, the user may perform the first trigger operation O2 on the reference identification 305, and reference information 410 or 420 of the first content block Block302 may be displayed in an association area 400 of the first content block Block302, where the reference information includes information of the second document documentB or documentC. FIG. 4 shows a schematic diagram of an association area of a content block according to embodiments of the present disclosure.

In some embodiments, in response to detecting the first trigger operation, for a user who does not have an access permission for reference information of the first content block, an association area of the first content area is refused from being displayed; or a request control for requesting for the access permission is displayed in the association area.

Before the first trigger operation O2 is detected in response or the reference information 410 or 420 of the first content block Block302 is displayed, it is also possible to determine whether the user has an access permission for reference information of the content block Block302 or Block303. The document owner userA of the first document documentA may set an access permission AuthorityB for reference information of the first document documentA. For example, the access permission AuthorityB for the reference information may be set to an edit permission, that is, a user with an edit permission may access the reference information of the first content block Block302 or Block303. If the user has a read permission, the user cannot access the reference information of the first content block Block302 or Block303. For example, the user performs the first trigger operation O2 on the reference identification 305. If the user has an access permission for the reference information 410 or 420, the reference information 410 or 420 may be displayed in the association area 400 of the first content block Block302. If the user does not have an access permission for the reference information, the association area 400 corresponding to the first content area is refused from being displayed. Further, if the user does not have an access permission for the reference information, the association area 400 may be displayed (in this case, the reference information 410 or 420 may not be displayed), and a request control for requesting for the access permission AuthorityB is displayed in the association area. The request control may request an access permission AuthorityB for the reference information from the owner userA or a related person with permission (for example, a user with an edit permission) of the first document documentA. If the owner userA or the related person with permission agrees to the permission request of the user, a corresponding consent response responseA may be returned. In response to the consent response responseA, the reference information 410 or 420 may be displayed in the association area 400. If the owner userA or the related person with permission does not agree to the permission request of the user, a corresponding rejection response responseB may be returned. In response to the rejection response responseB, the association area 400 may be refused from being displayed, or the association area 400 is displayed without the reference information 410 or 420 being displayed.

In some embodiments, the reference information includes at least one of a document identification, referrer information, or a reference time.

The document identification may be used to uniquely identify a document, for example, a document name, a document ID, a document address (for example, a link, etc.). The referrer information may refer to information of a referrer who references the content block in the first document, for example, a referrer ID. The reference time may refer to a time when the corresponding content block in the first document is referenced. If the second document references the same content block multiple times, the reference time may refer to a most recent reference time. Specifically, in FIG. 4, the association area 400 of the first content block includes at least one piece of reference information 410, 420, etc. The reference information 410 may include at least one of a document identification 411, referrer information 412, or a reference time 413 of the second document documentB. The reference information 420 includes at least one of a link 421, a referrer 422, or a reference time 423 of the second document documentC. A number of pieces of reference information included in the association area 400 of the first content block indicates a number of documents that reference the first content block, that is, a number of the second documents. Further, the reference information in the association area 400 of the first content block may be arranged based on a corresponding reference time. For example, a more recently referenced second document is ranked higher, that is, the second documents are arranged from top to bottom in order of reference time from recent to distant.

In some embodiments, a first content area is highlighted in the first document in response to detecting a second trigger operation for the information of the second document, where the first content area includes at least the first content block.

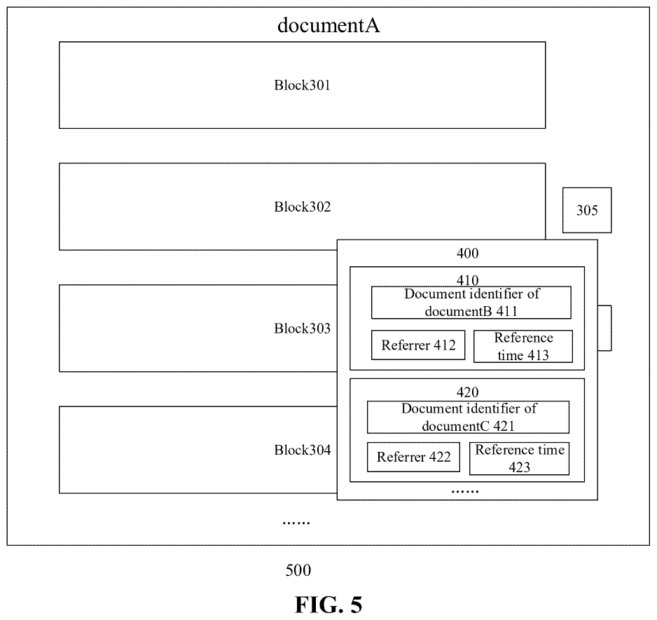

The user may further perform a second trigger operation O3 (for example, mouse hovering or clicking, etc.) on the information of the second document. In response to the second trigger operation O3, a first content area may be highlighted (for example, highlighted) in the first document documentA. The first content area may include at least one first content block. As shown in FIG. 5, FIG. 5 shows a schematic diagram of reference information according to embodiments of the present disclosure. In FIG. 5, the user performs the second trigger operation O3 on the reference information 420 (or the information of the second document), and the first content block Block302 referenced by the second document documentC may be highlighted. In this case, the first content area includes the first content block Block302. Further, in some embodiments, the first content area may further include a second content block, which is another content block referenced by the second document. For example, the second document documentC also references the content block Block303, and the content block Block303 may also be highlighted. In this case, the content block Block303 is the second content block. It can be seen that the second document documentC references both the first content block Block302 and the first content block Block303. In this way, highlighting the first content area enables the user to quickly and efficiently find the content referenced by the second document documentC, improving the convenience of the user.

In some embodiments, highlighting a first content area in the first document includes highlighting all content blocks referenced by the second document in the first document.

The one or more content blocks referenced by the second document documentC may be highlighted in the part of the first document displayed in an interface 500 shown in FIG. 5. Alternatively, the content blocks referenced by the second document documentC may also be highlighted in the entire first document documentA. When the user browses the first document documentA, the user can easily and quickly find which content blocks of the first document documentA are referenced by the second document documentC.

In some embodiments, the second content block is adjacent to the first content block; or
the second content block and the first content block are in a same content block group, where the content block group is a plurality of consecutive content blocks in a document; or
the second content block and the first content block are spaced by at least one third content block.

The second content block may be spaced from the first content block by another content block, for example, a third content block (not shown in the figure). Alternatively, the second content block may not be spaced from the first content block by another content block, for example, the first content block Block302 and the second content block Block303. The first content block and the second content block may also be content blocks in a same content block group including a plurality of consecutive content blocks.

In some embodiments, jumping to a target area of the second document in response to detecting a third trigger operation for a document identification of the second document, where the target area comprises the highlighted first content block.

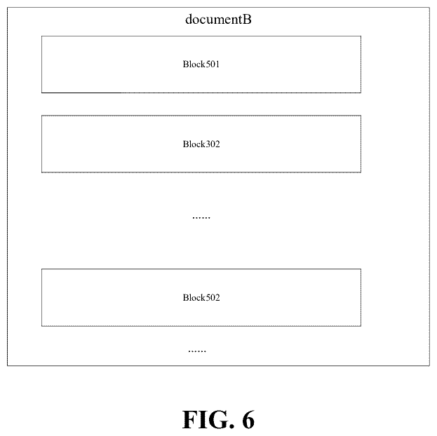

The user may further perform a third trigger operation O4 (for example, mouse hovering or clicking, etc.) on the document identification 411 or 421 of the second document documentB or documentC. In response to the third trigger operation O4, the user may jump to a target area of the corresponding second document documentB or documentC. The target area includes an area in the second document that references the first content block, and the first content block is highlighted in the target area. For example, if the user clicks on the document identification 411 (for example, a document link) of the second document documentB, the user may jump to the second document documentB. Further, the content block Block302 referenced in the first document is highlighted in the second document documentB. As shown in FIG. 6, FIG. 6 shows a schematic diagram of a second document according to embodiments of the present disclosure. Furthermore, a duration for highlighting may also be set, for example, highlighting for 3 seconds.

In some embodiments, if the first content block is referenced multiple times in the second document, the jumping to a target area of the second document includes jumping to a target area of the first content block which appears for the first time. Specifically, as shown in FIG. 6, the content block Block302 may be referenced once or multiple times in the second document documentB. After the user clicks on the document identification 411 of the second document documentB, the user may jump to an area in the second document documentB where the content block Block302 is referenced for the first time.

In some embodiments, a referrer information interface about the referrer is displayed in response to a fourth trigger operation for the referrer information, where the referrer information interface includes at least one of an instant messaging component and an email component. Further, in some embodiments, a communication page for the referrer in an instant messaging application is displayed in response to a fifth trigger operation for the communication component. Further, in some embodiments, an email page for the referrer is displayed in response to a sixth trigger operation for the email component.

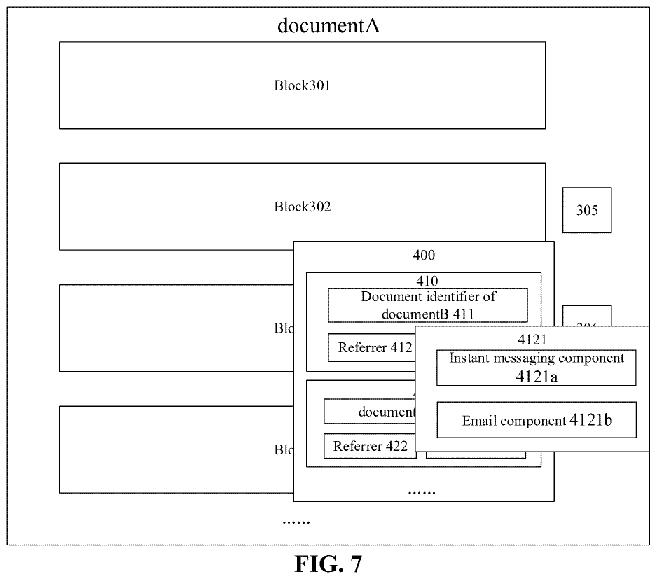

Specifically, as shown in FIG. 7, FIG. 7 shows a schematic diagram of an interface of referrer information according to embodiments of the present disclosure. In FIG. 7, the user may perform a fourth trigger operation O5 on the referrer information 412. In response to the fourth trigger operation O5, a referrer information interface 4121 corresponding to the referrer information 412 may be displayed. The referrer information interface 4121 may include a communication component that can communicate with a referrer. For example, the communication component may include an instant messaging component 4121a and/or an email component 4121b. Further, the user may also display a corresponding communication page by triggering the communication component. For example, a fifth trigger operation O6 may be performed on the instant messaging component 4121a. In response to the fifth trigger operation O6, a communication page Pa corresponding to the instant messaging component 4121 a may be displayed. The user may communicate with the referrer indicated by the referrer information 412 through the communication page Pa, for example, send an instant message. A sixth trigger operation O7 may also be performed on the email component 4121b. In response to the sixth trigger operation O7, a communication page Pb corresponding to the email component 4121b may be displayed. The user may communicate with the referrer indicated by the referrer information 412 through the communication page Pb, for example, send an email.

In some embodiments, in response to detecting that content of the first content block is changed, the second document is updated based on the changed content.

A user with an edit permission or the document owner userA may edit the first document documentA. If it is detected that content of the referenced content block changes, the corresponding content block in the second document documentB or documentC also changes to be consistent with the first document documentA.

In some embodiments, the second document includes a first target document and a second target document different from the first target document, the first target document including a document in the second document that corresponds to the first content area; and
the method further includes:
highlighting a second content area in the first document in response to detecting a seventh trigger operation for information of the second target document, where the second content area at least comprises the first content block and a fourth content block, and the fourth content block is another content block referenced by the second target document.

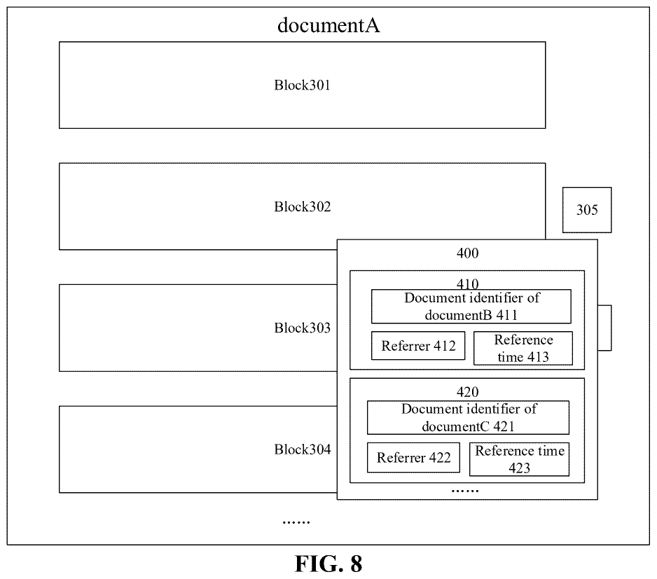

The reference information 410 and 420 is displayed in the association area 400 in response to the first trigger operation for the first content block Block302, that is, the information 410 of the second document documentB and the information 420 of the second document documentC, as shown in FIG. 4. As shown in FIG. 5, the user performs the second trigger operation on the information 420 of the second document documentC to highlight the first content area including the content block Block302 and the content block Block303. In this case, the second document documentC is the first target document in the second documents. Referring to FIG. 8, FIG. 8 shows a schematic diagram of a second content area according to embodiments of the present disclosure. In FIG. 8, the user may also perform a seventh trigger operation O8 on the information 410 of the second document documentB. In response to the seventh trigger operation O8, the second content area including the content block Block301, the content block Block302, and the content block Block303 may be highlighted in the first document. In this case, the second document documentB is the second target document in the second documents, and the content block Block301 and the content block Block303 are the fourth content blocks.

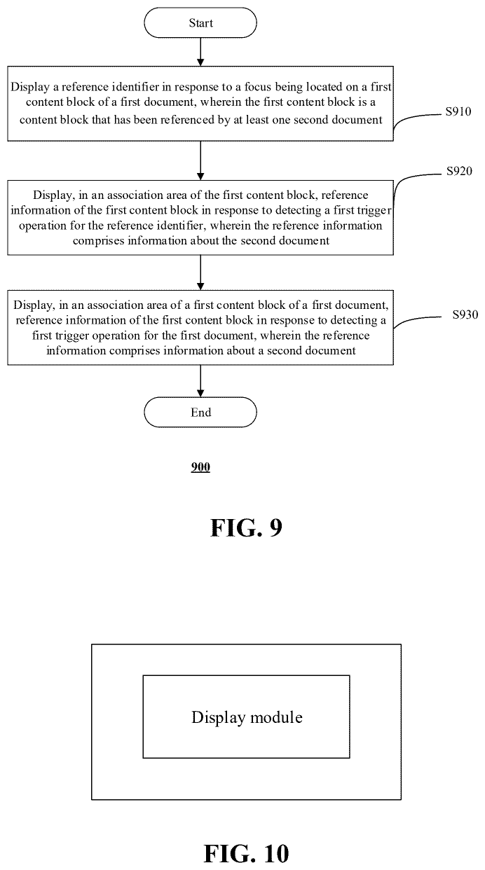

Referring to FIG. 9, FIG. 9 shows a schematic flowchart of a method for accessing a document according to embodiments of the present disclosure. In FIG. 9, a method 900 for accessing a document may include the following steps.

Step S910: Display a reference identification (for example, the reference identification 305 in FIG. 3) in response to a focus being located on a first content block (for example, the content block Block302 in FIG. 3) of a first document (for example, documentA in FIG. 3), where the first content block is a content block that has been referenced by at least one second document (for example, documentB or documentC in FIG. 4);

Step S920: Display, in an association area (for example, the association area 400 in FIG. 4) of the first content block, reference information (for example, the reference information 410 and 420 in FIG. 4) of the first content block in response to detecting a first trigger operation (for example, the first trigger operation O2) for the reference identification, where the reference information includes information of the second document; and

Step S930: Highlight a first content area in the first document in response to detecting a second trigger operation (for example, the second trigger operation O3) for the information of the second document (for example, the information 420 in FIG. 5), where the first content area includes at least the first content block (for example, the content block Block302 in FIG. 5).

In some embodiments, the first content area further includes a second content block (for example, the content block Block303 in FIG. 5), where the second content block is another content block referenced by the second document (for example, the second document documentC in FIG. 5).

In some embodiments, the second content block (for example, the content block Block303 in FIG. 5) is adjacent to the first content block (for example, the content block Block302 in FIG. 5); or
the second content block and the first content block are in a same content block group, where the content block group is a plurality of consecutive content blocks in a document; or
the second content block and the first content block are spaced by at least one third content block.

In some embodiments, highlighting a first content area in the first document includes highlighting all content blocks (for example, the content block Block302 and the content block Block303 in FIG. 5) referenced by the second document in the first document.

In some embodiments, the reference information includes at least one of a document identification (for example, the document identification 411 or 421 in FIG. 5), referrer information (for example, the referrer information 412 or 422 in FIG. 5), or a reference time (for example, the reference time 413 or 423 in FIG. 5).

In some embodiments, the method 900 further includes:
jumping to a target area (for example, the content block Block302 in FIG. 6) of the second document in response to detecting a third trigger operation (for example, the third trigger operation O4) for a document identification (for example, the document identification 411 in FIG. 5) of the second document, where the target area includes the highlighted first content block.

In some embodiments, if the first content block is referenced multiple times in the second document, the jumping to a target area of the second document includes jumping to a target area of the first content block which appears for the first time (for example, the content block Block302 in FIG. 6).

In some embodiments, the method 900 further includes:
displaying a referrer information interface (for example, the referrer information interface 4121 in FIG. 7) about the referrer in response to a fourth trigger operation (for example, the fourth trigger operation O5) for the referrer information, where the referrer information interface includes at least one of the following: an instant messaging component (for example, the instant messaging component 4121a in FIG. 7) and an email component (for example, the email component 4121b in FIG. 7).

In some embodiments, the method 900 further includes: displaying a communication page for the referrer in an instant messaging application in response to a fifth trigger operation (for example, the fifth trigger operation O6) for the communication component.

In some embodiments, the method 900 further includes: displaying an email page for the referrer in response to a sixth trigger operation (for example, the sixth trigger operation O7) for the email component.

In some embodiments, the method 900 further includes:
updating, in response to detecting that content of the first content block changes, the second document based on the changed content.

In some embodiments, the reference identification includes a number identification (for example, the number identification N in FIG. 3) for indicating a number of the second documents.

In some embodiments, the method 900 further includes:
in response to the reference identification being displayed, further displaying a comment identification (for example, the comment identification 305′ in FIG. 3) about the first content block.

In some embodiments, the method 900 further includes:
in response to detecting the first trigger operation, for a user who does not have an access permission for reference information of the first content block, refusing to display an association area (for example, the association area 400 in FIG. 4) of the first content area; or displaying a request control for requesting for the access permission in the association area.

In some embodiments, the displaying a reference identification includes:
displaying the reference identification for a user who has an access permission for the first document; and/or
refusing to display the reference identification for a user who does not have an access permission for the first document.

In some embodiments, the second document includes a first target document (for example, the documentC in FIG. 8) and a second target document (for example, the documentB in FIG. 8) different from the first target document, the first target document including a document in the second document that corresponds to the first content area; and
the method 900 further includes:
highlighting a second content area (for example, the content block Block301, the content block Block302, and the content block Block303 in FIG. 8) in the first document in response to detecting a seventh trigger operation (for example, the seventh trigger operation O8) for information of the second target document, where the second content area includes at least the first content block and a fourth content block (for example, the content block Block301 and the content block Block303 in FIG. 8), and the fourth content block is another content block referenced by the second target document.

It should be noted that the method of the embodiments of the present disclosure may be performed by a single device, such as a computer or a server. The method of these embodiments may also be applied in a distributed scenario, and completed by a plurality of devices cooperating with each other. In this distributed scenario, one of the plurality of devices may only perform one or more steps of the method of the embodiments of the present disclosure, and the plurality of devices will interact with each other to complete the method.

It should be noted that some embodiments of the present disclosure are described above. Other embodiments are within the scope of the appended claims. In some cases, the actions or steps recited in the claims may be performed in a different order than in the embodiments described above and still achieve the desired results. In addition, the processes depicted in the accompanying drawings do not necessarily require the specific order or sequential order shown to achieve the desired results. In some implementations, multitasking and parallel processing are also possible or may be advantageous.

Based on the same technical concept, corresponding to the method in any of the foregoing embodiments, the present disclosure further provides an apparatus for accessing a document.

Referring to FIG. 10, an apparatus for accessing a document includes:
a display module configured to display a reference identification in response to a focus being located on a first content block of a first document, where the first content block is a content block that has been referenced by at least one second document; and
display, in an association area of the first content block, reference information of the first content block in response to detecting a first trigger operation for the reference identification, where the reference information comprises information of the second document; and
highlight a first content area in the first document in response to detecting a second trigger operation for the information of the second document, where the first content area at least comprises the first content block.

For the convenience of description, the above apparatus is described as various modules according to functions. Certainly, when implementing the present disclosure, the functions of the modules may be implemented in one or more software and/or hardware.

The apparatus of the foregoing embodiments is configured to implement the corresponding method for accessing a document in any of the foregoing embodiments, and has beneficial effects of the corresponding method embodiments, which will not be repeated here.

Based on the same technical concept, corresponding to the method in any of the foregoing embodiments, the present disclosure further provides a non-transitory computer-readable storage medium storing computer instructions, where the computer instructions are configured to cause the computer to perform the method for accessing a document according to any of the foregoing embodiments.

The computer-readable medium in these embodiments includes a permanent and non-permanent, removable and non-removable medium, and information storage may be implemented by any method or technology. The information may be computer-readable instructions, a data structure, a program module, or other data. Examples of the computer storage medium include, but are not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory, or other memory technologies, compact disc read-only memory (CD-ROM), digital versatile disc (DVD), or other optical storage, magnetic cassette tape, magnetic tape, magnetic disk storage, or other magnetic storage devices, or any other non-transmission medium, which may be used to store information accessible by a computing device.

The computer instructions stored in the storage medium of the foregoing embodiments are configured to cause the computer to perform the method for accessing a document according to any of the foregoing embodiments, and have beneficial effects of the corresponding method embodiments, which will not be repeated here.

Based on the same technical concept, corresponding to the method in any of the foregoing embodiments, the present disclosure further provides a computer program product, including computer program instructions, where when the computer program instructions are run on a computer, the computer is caused to perform the method for accessing a document according to any of the foregoing embodiments.

A person of ordinary skill in the art should understand that the discussion of any of the foregoing embodiments is exemplary only, and is not intended to imply that the scope of the present disclosure (including claims) is limited to these examples. Under the concept of the present disclosure, the technical features in the above embodiments or different embodiments may also be combined, the steps may be implemented in any order, and there are many other variations of different aspects of the embodiments of the present disclosure as described above. For the sake of brevity, they are not provided in the details.

In addition, to simplify the description and discussion, and in order not to make the embodiments of the present disclosure difficult to understand, well-known power/ground connections to integrated circuit (IC) chips and other components may be shown or may not be shown in the provided drawings. In addition, the apparatus may be shown in the form of a block diagram, so as to avoid making the embodiments of the present disclosure difficult to understand, and this also takes into account the fact that details of the implementation of these block diagram apparatuses are highly dependent on the platform on which the embodiments of the present disclosure are to be implemented (that is, these details should be completely within the understanding of those skilled in the art). When the specific details (such as a circuit) are set forth to describe the exemplary embodiments of the present disclosure, it will be apparent to those skilled in the art that the embodiments of the present disclosure may be implemented without these specific details or with changes to these specific details. Therefore, these descriptions should be considered as illustrative rather than restrictive.

Although the present disclosure has been described in conjunction with specific embodiments of the present disclosure, many alternatives, modifications, and variations of these embodiments will be apparent to those of ordinary skill in the art from the foregoing description. For example, other memory architectures (such as dynamic RAM (DRAM)) may use the discussed embodiments.

The embodiments of the present disclosure are intended to cover all such alternatives, modifications, and variations that fall within the broad scope of the appended claims. Therefore, any omission, modification, equivalent replacement, improvement, etc. made within the spirit and principle of the embodiments of the present disclosure shall be included within the protection scope of the present disclosure.

1. A method for accessing a document, comprising:
displaying a reference identification in response to a focus being located on a first content block of a first document, wherein the first content block is a content block that has been referenced by at least one second document;
displaying, in an association area of the first content block, reference information of the first content block in response to detecting a first trigger operation for the reference identification, wherein the reference information comprises information of the second document; and
highlighting a first content area in the first document in response to detecting a second trigger operation for the information of the second document, wherein the first content area at least comprises the first content block.

2. The method according to claim 1, wherein the first content area further comprises a second content block, and the second content block is another content block referenced by the second document.

3. The method according to claim 2, wherein the second content block is adjacent to the first content block; or
the second content block and the first content block are in a same content block group, the content block group being a plurality of consecutive content blocks in a document; or
the second content block and the first content block are spaced by at least one third content block.

4. The method according to claim 1, wherein highlighting the first content area in the first document comprises: highlighting all content blocks referenced by the second document in the first document.

5. The method according to claim 1, wherein the reference information comprises at least one of a document identification, referrer information, or a reference time.

6. The method according to claim 5, further comprising:
jumping to a target area of the second document in response to detecting a third trigger operation for a document identification of the second document, wherein the target area comprises the highlighted first content block.

7. The method according to claim 6, wherein in response to the first content block being referenced multiple times in the second document, jumping to the target area of the second document comprises:
jumping to a target area of the first content block which appears for the first time.

8. The method according to claim 5, further comprising:
displaying a referrer information interface about the referrer in response to a fourth trigger operation for the referrer information, wherein the referrer information interface comprises at least one of an instant messaging component or an email component.

9. The method according to claim 8, further comprising: displaying a communication page for the referrer in an instant messaging application in response to a fifth trigger operation for the at least one of the instant messaging component or the email component.

10. The method according to claim 8, further comprising: displaying an email page for the referrer in response to a sixth trigger operation for the email component.

11. The method according to claim 1, further comprising:
updating, in response to detecting that content of the first content block is changed, the second document based on the changed content.

12. The method according to claim 1, wherein the reference identification comprises a number identification for indicating a number of the second documents.

13. The method according to claim 1, further comprising:
in response to the reference identification being displayed, further displaying a comment identification about the first content block.

14. The method according to claim 1, further comprising:
in response to detecting the first trigger operation, for a user who does not have an access permission for the reference information of the first content block, refusing to display an association area of the first content area, or displaying a request control for requesting for the access permission in the association area.

15. The method according to claim 1, wherein displaying the reference identification comprises:
displaying the reference identification for a user who has an access permission for the first document; and/or
refusing to display the reference identification for a user who does not have the access permission for the first document.

16. The method according to claim 1, wherein the second document comprises a first target document and a second target document different from the first target document, the first target document comprising a document in the second document that corresponds to the first content area; and
the method further comprises:
highlighting a second content area in the first document in response to detecting a seventh trigger operation for information of the second target document, wherein the second content area at least comprises the first content block and a fourth content block, and the fourth content block is another content block referenced by the second target document.

17. (canceled)

18. An electronic device, comprising a memory, a processor, and a computer program stored in the memory and executable on the processor, wherein the program, when executed by the processor, causes the device to:
display a reference identification in response to a focus being located on a first content block of a first document, wherein the first content block is a content block that has been referenced by at least one second document;
display, in an association area of the first content block, reference information of the first content block in response to detecting a first trigger operation for the reference identification, wherein the reference information comprises information of the second document; and
highlight a first content area in the first document in response to detecting a second trigger operation for the information of the second document, wherein the first content area at least comprises the first content block.

19. A non-transitory computer-readable storage medium storing computer instructions, wherein the computer instructions are configured to cause a computer to:
display a reference identification in response to a focus being located on a first content block of a first document, wherein the first content block is a content block that has been referenced by at least one second document;
display, in an association area of the first content block, reference information of the first content block in response to detecting a first trigger operation for the reference identification, wherein the reference information comprises information of the second document; and
highlight a first content area in the first document in response to detecting a second trigger operation for the information of the second document, wherein the first content area at least comprises the first content block.

20. (canceled)

21. The device according to claim 18, wherein the first content area further comprises a second content block, and the second content block is another content block referenced by the second document.

22. The device according to claim 21, wherein the second content block is adjacent to the first content block; or
the second content block and the first content block are in a same content block group, the content block group being a plurality of consecutive content blocks in a document; or
the second content block and the first content block are spaced by at least one third content block.
